(19) United States
(12) Patent Application Publication
(10) Pub. No.: US 2024/0230330 A1
(43) Pub. Date: Jul. 11, 2024

(54) TILT INDICATOR

(71) Applicant: ShockWatch, Inc, Dallas, TX (US)

(72) Inventors: Johannes van Niekerk, Dallas, TX (US); Cuong Viet Nguyen, Garland, TX (US); Gaurav Pandit, Dallas, TX (US); Swapnil Suresh Chaughule, Dallas, TX (US)

(21) Appl. No.: 18/408,856

(22) Filed: Jan. 10, 2024

Related U.S. Application Data
(60) Provisional application No. 63/438,117, filed on Jan. 10, 2023.

(51) Int. Cl. G01C 9/06

(52) U.S. Cl. CPC G01C 9/06; G01C 2009/062

(57) ABSTRACT

A tilt indicator includes a tilt detection assembly including a mass movable from a first position to a second position in response to a tilt event. A capacitance sensor circuit is disposed proximate the first position. The capacitance sensor circuit is configured to output a capacitance value based on the mass being in the first position. A module and logic integrated with and/or executable by the module is coupled to the capacitance sensor circuit, the module configured to output, when energized, an indication of an actuation state of the tilt indicator based on the capacitance value. The capacitance sensor circuit may be energized from by a wireless communication module, such as an RFID chip, by a remote reader device.

### CROSS-REFERENCE TO RELATED APPLICATIONS

This application claims priority to provisional U.S. Application No. 63/438,117, filed on Jan. 10, 2023, the contents of which are herein incorporated in their entirety by reference.

### BACKGROUND

During manufacturing, storage, transit, or usage, many types of objects need to be monitored or tracked due to the tilt sensitivity or fragility of the objects. For example, in today's global economy, goods, materials, manufactured articles, and the like are often transported great distances before reaching their final destination. The shipping process may involve multiple transportation methods. For instance, it is not uncommon for a product manufactured in Asia, to be loaded on a truck, transported to a rail station, loaded onto a railcar, transported by rail to a port, loaded onto a cargo ship, transported overseas to a port, loaded onto a truck, transported over road by truck, and delivered to a warehouse. Once at the warehouse, the product may again be shipped via air or ground before reaching the ultimate user of the product. During this process, the product may be loaded and unloaded many times and may be occasionally damaged as a result of handling mishaps. Some products are susceptible to damage if they are not transported in a certain position. For example, some computer hard drives are known to malfunction if they are turned on their sides or upside down. Thus, some types of objects may be susceptible to damage if upended, turned over, or tilted at greater than a predetermined angle. Thus, for quality control purposes and/or the general monitoring of transportation conditions, it is desirable to determine and/or verify the environmental conditions an object has experienced.

### BRIEF SUMMARY

According to one aspect of the present disclosure, a tilt indicator includes a tilt detection assembly including a mass movable from a first position to a second position in response to a tilt event. A capacitance sensor circuit is disposed proximate the first position and is configured to output a capacitance value based on the mass being in the first position. A module and logic integrated with and/or executable by the module is coupled to the capacitance sensor circuit and outputs, when energized, an indication of an actuation state of the tilt indicator based on the capacitance value.

According to another embodiment of the present disclosure, a tilt indicator includes a tilt detection assembly including a mass movable from a first position in response to a tilt event. A capacitance sensor circuit is disposed proximate the first position. The capacitance sensor circuit is configured to output a first capacitance value based on the mass being in the first position and a second capacitance value based on the mass being absent from the first position. A module and logic integrated with and/or executable by the module is coupled to the capacitance sensor circuit and outputs, when energized, an indication of an actuation state of the tilt indicator based on the first capacitance value and/or the second capacitance value output by the capacitance sensor circuit.

According to yet another embodiment of the present disclosure, a tilt indicator includes a tilt detection assembly including a mass movable from a first position in response to a tilt event. A capacitance sensor circuit includes a first conductive plate and a second conductive plate disposed proximate the first position. A module and logic integrated with and/or executable by the module is coupled to the capacitance sensor circuit. The module is configured to, when energized: power the capacitance sensor circuit; determine a capacitance value from the capacitance sensor circuit; and output an indication of an actuation state of the tilt indicator based on the capacitance value.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures.

FIG. 1 is a diagram illustrating an application of an embodiment of a tilt indicator according to the present disclosure;

FIG. 2 is a diagram illustrating an embodiment of a tilt indicator in accordance with the present disclosure in an unactuated state;

FIG. 3 is a diagram illustrating an embodiment of the tilt indicator of FIG. 2 in accordance with the present disclosure in an actuated state;

FIG. 4 is a diagram illustrating a section view of a portion of the tilt indicator of FIG. 2 taken along the line 4-4 of FIG. 2; and

FIG. 5 is a block diagram illustrating an embodiment of the tilt indicator of FIGS. 1 and 2 according to the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

As used herein, the terms “first”, “second”, and “third” may be used interchangeably to distinguish one component from another and are not intended to signify location or importance of the individual components.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

Embodiments of the present disclosure provide a device and technique for tilt detection and indication. According to one embodiment, a tilt indicator includes a capacitance sensor circuit comprising a pair of conductive plates located proximate to a location of a movable mass. Responsive to the tilt detection assembly being subjected to a tilt event exceeding a threshold, the mass moves away from the location of the conductive plates. The capacitance sensor circuit may be energized from a wireless communication module, such as an RFID circuit, based on the RFID chip being energized from a remote RFID reader device. When energized or powered, the capacitance sensor circuit outputs a capacitance value based on the position of the mass in the tilt indicator. The wireless communication module outputs a value based on the capacitance value output by the capacitance sensor circuit. Embodiments of the present disclosure enable tilt event detection using no internal power supply. Embodiments of the present disclosure provide a tilt indicator that is readily affixable to a container, an item or the like so as to provide at least an indication when a particular container or component has been subjected to a particular environmental tilt. Embodiments of the present disclosure also provide a tilt indicator that is an irreversible, “go-no go” device for indicating that a predetermined tilt has been experienced by the indicator.

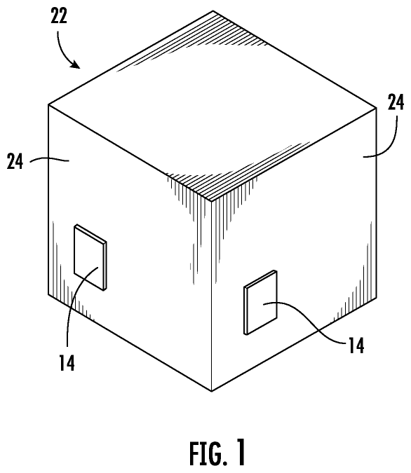

With reference now to the figures and in particular with reference to FIG. 1, exemplary diagrams of a tilt indicator are provided. Referring to FIG. 1, an object, such as a shipping package 22, has one or more tilt indicators 14 affixed on one or more walls 24 thereof for determining whether the package has been maintained in its recommended orientation during shipment and not tilted beyond a predetermined maximum angle. The shipping package 22 may be of any of the conventional form, such as crates, pallets, boxes, cartons, barrels, drums, cans, bottles or other containers emplaced about the goods before shipping. Alternatively, tilt indicator(s) 14 could be placed directly onto the goods themselves. Thus, an object bearing tilt indicator 14 could be goods, a container bearing goods, etc. In order to detect unauthorized tilting, tilt indicator 14 is preferably placed on an upright or side wall 24 of the shipping package 22 when in the upright position. In some embodiments, tilt indicator 14 is sensitive in at least two dimensions, namely in the plane of indicator 14 (e.g., a plane corresponding to wall 24). Thus, tilt indicator 14 may be used in combination with another tilt indicator 14 placed on an adjacent side wall 24 of the package 20 wherein the two tilt indicators 14 are transverse to one another.

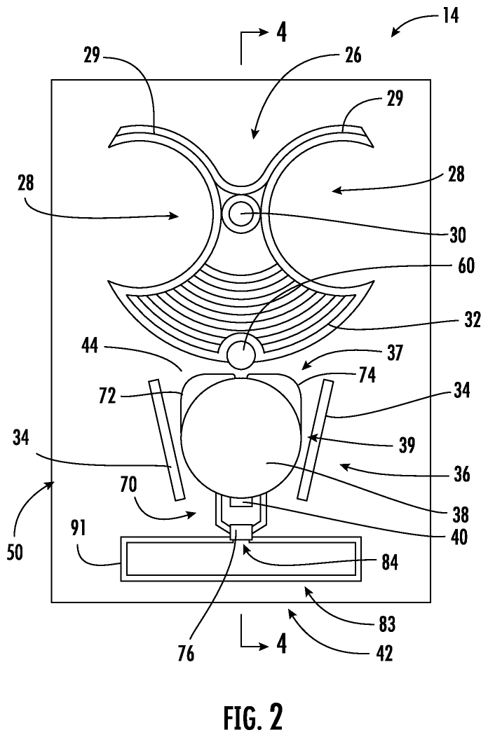

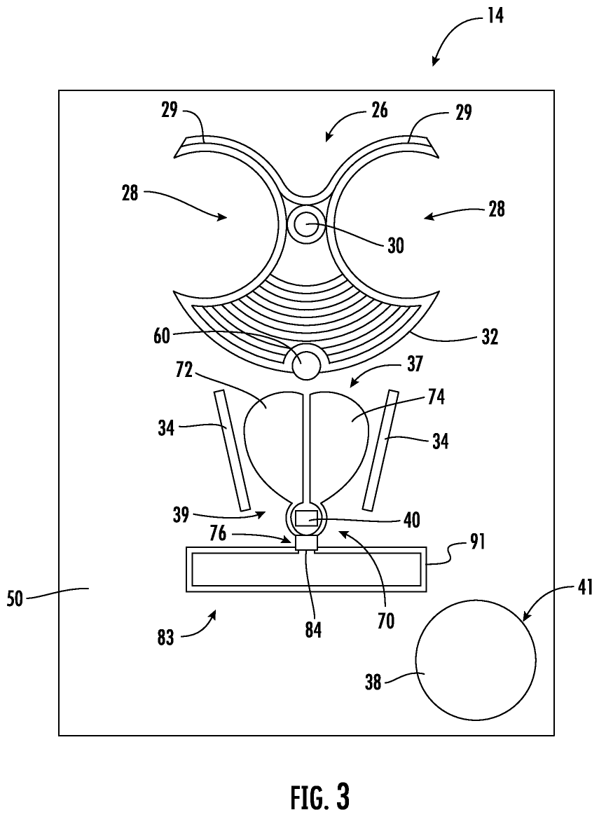

FIG. 2 is a diagram illustrating an embodiment of tilt indicator 14 in accordance with the present disclosure in an unactuated state, and FIG. 3 is a diagram illustrating the tilt indicator 14 of FIG. 1 in accordance with the present disclosure in an activated state. The mechanical operation of tilt indicator 14 is similar to the commercially available tilt indicator Tilt Watch XTR available from SpotSee of Dallas, Texas, and also described more fully in U.S. Pat. No. 7,353,615 which is incorporated, in its entirety, herein by reference.

In FIG. 2, tilt indicator 14 has a container or housing 42 supporting a tilt detection assembly 16 including a receptacle 36 adjacent to a base plate or support member 50 that has a closed end 40, an open end 44, and sides 34 that extend between the closed end 40 and open end 44. In exemplary embodiments, mass 38 is also configured as a conductive element. Mass 38 may also be variously configured (e.g., formed entirely from a conductive material, having a conductive coating applied to a non-conductive underlying material, etc.). Receptacle 36, which may also be referred to as a retaining receptacle, receives mass 38 therein. In some embodiments, mass 38 is a disc because tilt indicator 14 is configured having a thin profile.

In the illustrated embodiment, receptacle 36 is configured in the form of a V-shape or flared horseshoe shape with closed end 40 of the V or horseshoe located near the base of tilt indicator 14. Open end 44 is located above closed end 40 when indicator 14 is in the upright, or vertical, position. Sides 34 of the V or horseshoe extend from closed end 40 of receptacle 36 at angles relative to one another so as to allow mass 38 to rest within a cavity or receptacle region 37 formed by the sides 34 and the closed end 40, and to escape receptacle 36 when tilt indicator 14 is inclined beyond a predetermined angle. In the normal, upright orientation of tilt indicator 14 (i.e., unactuated due to a tilt event), mass 38 is located inside of receptacle 36 in the receptacle region 37 in an unactuated position 39. When receptacle 36 is tilted beyond a predetermined angle, mass 38 exits receptacle 36. In some embodiment, this angle is generally the angle at which one of the sides 34 is oriented at or below horizontal. For example, when indicator 14 is tilted to say, 80 degrees from its upright orientation, then mass 38 can exit receptacle 36. The slope or angle of the sides 34 determines the angle at which indicator 14 will become actuated. Accordingly, the slope or angle of the sides 34 may be varied to a desired angle of indicator 14 actuation. Further, in the illustrated embodiment, indicator 14 is bi-directional and is activated by tilting indicator 14 beyond the predetermined angle towards either of sides 34 of receptacle 36. In exemplary embodiments, the tilt event results in the mass 38 exiting the receptacle 36 such that the mass 38 moves from the unactuated position 39 to an actuated position 41 as depicted in FIG. 3.

Referring to FIG. 2, receptacle 36 is located within housing 42 and, in some embodiments, housing 42 is configured having a thin profile. Accordingly, in this embodiment, mass 38 can only move in two dimensions, for practical purposes (there may be some minimal movement in a third dimension (e.g., between support member 50 and the face of housing 42 (not expressly shown in FIG. 2).

Occasionally, mass 38 will move in response to vibrational frequencies to which mass 38 is sensitive or responsive. This movement could in some cases cause mass 38 to escape from receptacle 36 even in the absence of receptacle 36 tilting, resulting in a false indication of tilting. In order to prevent such a false indication under this set of vibrational frequencies, tilt detection assembly 16 is configured such that the exit of receptacle 36 by mass 38 is blocked by a hanging mass 26 of tilt detection assembly 16. Hanging mass 26 is suspended adjacent to open end 44 and has a pivot point 30 around which hanging mass 26 pivots in a plane parallel with member 50 and/or mass 38. When receptacle 36 is in its normal, untilted or unactuated orientation, hanging mass 26 blocks the exit of mass 38 from receptacle 36. Thus, even if vibration moves mass 38 toward open end 44, tilt indicator 14 does not activate. Hanging mass 26 is generally not sensitive or responsive to the same vibrational frequencies as mass 38. Instead, hanging mass 26 is responsive to a second, different set of vibrational frequencies. Hanging mass 26, while preventing false activation, does not interfere with normal operation of indicator 14. When receptacle 36 is tilted beyond the predetermined angle, hanging mass 26 moves so as to allow mass 38 to exit receptacle 36. A tilting indication or activation occurs when mass 38 has exited receptacle 36.

Hanging mass 26 has at least two lateral wings 29 or arms located above a blocking portion 32 of mass 26, as shown in FIG. 2. Wings 29 are located on the opposite side of pivot point 30 from the blocking portion 32 and form lateral cavities 28 at least slightly larger than the diameter of mass 38. Although the illustrated embodiment has lateral cavities 28, tilt indicator 14 without lateral cavities 28 will prevent the escape of mass 38 in the presence of vibrational frequencies to which mass 38 is sensitive.

Once mass 38 exits receptacle 36 and enters the exposed lateral cavity 28 of hanging mass 26, the weight of mass 38 within the lateral cavity 28 will further cause hanging mass 26 to pivot. Mass 38 will then fall from the lateral cavity 28 into the non-receptacle part of the housing 42. Once the shipping package 22 is re-oriented to the upright position, hanging mass 26 returns to the blocking position depicted in FIG. 2 and mass 38 remains outside the retaining receptacle 36, such as in the actuated position 41 (FIG. 3).

Thus, hanging mass 26 acts as a pendulum, maintaining its orientation due to gravity. When receptacle 36 is upright, hanging mass 26 blocks open end 44 of receptacle 36. When tilt indicator 14 is tilted, hanging mass 26 moves and no longer blocks open end 44. Wings 29 of hanging mass 26 prevent reentry of mass 38 upon escape of mass 38 from receptacle 36.

In order to make tilt indicator 14 field armable so that tilt indicator 14 is prevented from being actuated until ready, an arming mechanism 60 is provided, as shown in FIG. 2. In exemplary embodiments, the arming mechanism 60 may comprise a pin or other type of device or structure such that removal or displacement of the arming mechanism 60 activates the tilt indicator 14. In the illustrated embodiment, the arming mechanism 60 prevents mass 38 from escaping receptacle 36 and remains in place until such time as arming mechanism 60 is removed or displaced and indicator 14 is placed into service (i.e., removal or displacement of the arming mechanism 60 places the tilt indicator 14 in an activated state or a state enabling the tilt indicator 14 to detect and indicate a tilt event).

In exemplary embodiments, the tilt indicator 14 includes a capacitance sensor circuit 70. In exemplary embodiments, at least a portion of the capacitance sensor circuit 70 is disposed proximate the mass 38 when the mass 38 is in the unactuated position 39 (i.e., when the mass 38 is located in the receptacle 36). In exemplary embodiments, the capacitance sensor circuit 70 includes plates 72 and 74 disposed proximate the receptacle 36 such that the plates 72 and 74 are disposed proximate the mass 38 when the mass 38 is disposed within the receptacle 36 in the unactuated position 39. In FIG. 2, at least a portion of the plates 72 and 74 are obstructed from view by the mass 38. In exemplary embodiments, the plates 72 and 74 comprise conductive plates 72 and 74. However, it should be understood that the plates 72 and 74 may be configured having a conductive coating applied to a non-conductive underlying material. Thus, in exemplary embodiments, at least a portion of each of the plates 72 and 74 is positioned in the receptacle region 37 such that at least a portion of each of the plates 72 and 74 are located proximate the mass 38 when the mass 38 is in the receptacle region 37.

In exemplary embodiments, the plates 72 and 74 are positioned spaced apart from each other in the receptacle region 37. In exemplary embodiments, at least a portion of each of the plates 72 and 74 are disposed substantially co-planar with each other, such as in a plane substantially parallel to a plane in which the mass 38 resides when the mass 38 is in the receptacle 36. In exemplary embodiments, the plates 72 and 74 are disposed on a side of the support member 50 facing the mass 38 such that at least a portion of each of the plates 72 and 74 is disposed between the support member 50 and the mass 38 when the mass 38 is located in the receptacle 36. In exemplary embodiments, the plates 72 and 74 are positioned such that when the mass 38 is in the receptacle 36, the mass 38 extends over or covers at least a portion of each of the plates 72 and 74.

In exemplary embodiments, the capacitance sensor circuit 70 includes a capacitance sensor interface 76. Each of the plates 72 and 74 is separately coupled to the capacitance sensor interface 76. In exemplary embodiments, the tilt indicator 14 also includes a wireless communication module 83 coupled to the capacitance sensor circuit 70. In exemplary embodiments, the wireless communication module 83 may comprise an RFID module 84. In some embodiments, the RFID module 84 comprises a passive RFID module 84 (e.g., a passive RFID chip or tag). In exemplary embodiments, the capacitance sensor interface 76 may form part of the RFID module 84. As illustrated in FIGS. 2 and 3, the wireless communication module 83 includes an antenna 91. Accordingly, in exemplary embodiments, the antenna 91 is coupled to the RFID module 84. In exemplary embodiments, the antenna 91 is disposed on the support member 50. However, it should be understood that the antenna 91 may be otherwise located on the tilt indicator 14.

In operation, the wireless communication module 83 is configured to wirelessly communicate information associated with an actuation state of the tilt indicator 14 (e.g., based on whether the mass 38 is in the unactuated position 39 (FIG. 2) or the actuated position 41 (FIG. 3). For example, in exemplary embodiments, the wireless communication module 83 includes the RFID module 84. In some embodiments, the RFID module 84 comprises a passive RFID module 84 (e.g., a passive RFID chip or tag) having an RFID integrated circuit or circuitry (e.g., disposed on or as part of a printed circuit board) and a memory, along with the antenna 91. As a passive RFID module 84, indicator 14 does not contain a battery (e.g., power is supplied by an RFID reader 100). For example, when radio waves from a reader 100, such as an RFID reader, are encountered by the RFID module 84, the antenna 91 forms a magnetic field, thereby providing power to the RFID module 84 to energize the circuitry of the RFID module 84. Once energized, the RFID module 84 may output or transmit information encoded in its memory or, in exemplary embodiments, a capacitance value based on a state of the capacitance sensor circuit 70. However, it should be understood that, in some embodiments, RFID module 84 may comprise an active RFID module 84 including a power source (e.g., a battery) that may be configured to continuously, intermittently, and/or according to programmed or event triggers, broadcast or transmit certain information.

In operation, a capacitance value measured between the plates 72 and 74 changes based on whether the mass 38 is disposed proximate the plates 72 and 74 (i.e., whether the mass 38 is within the receptacle 36). In exemplary embodiments, in response to the wireless communication module 83 being energized (e.g., via an RFID reader), the capacitance sensor circuit 70 is powered via the capacitance sensor interface 76 enabling a voltage to be applied to the capacitance sensor circuit 70. If the mass 38 is not adjacent to the plates 72 and 74 (e.g., the mass 38 is not in the unactuated position 39), a capacitance value or capacitance reading decreases compared to a capacitance value or reading if the mass 38 is located adjacent to the plates 72 and 74 (i.e., the mass 38 located in the unactuated position 39). The wireless communication module 83 is configured to read or detect a capacitance value between the plates 72 and 74 and wirelessly communicate the capacitance reading or value when energized by a remote reader device.

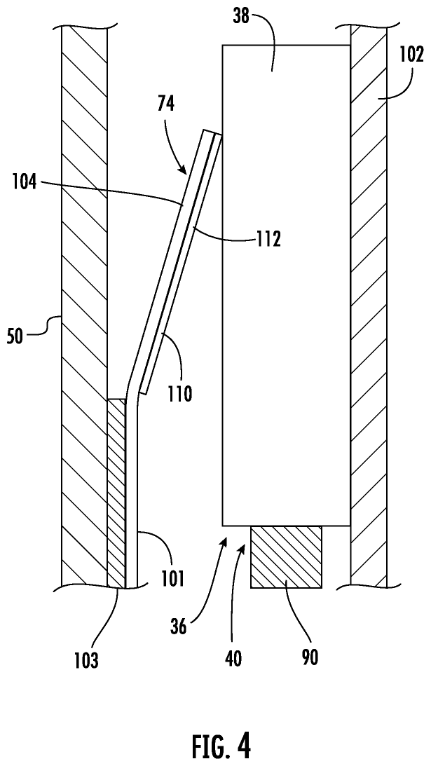

FIG. 4 is a schematic diagram illustrating a section view of the tilt indicator 14 of FIGS. 1-3 taken along the line 4-4 of FIG. 2. In FIG. 4, the mass 38 is disposed within the receptacle 36 resting upon a support member 90 defining the closed end 40 of the receptacle 36. In the illustrated embodiment, only plate 74 is depicted. However, it should be understood that the plate 72 may be similarly configured and located as described in connection with the plate 74.

In exemplary embodiments, at least a portion 101 of the plate 74 is secured to the support member 50. The portion 101 may be secured to the support member 50 via an adhesive layer 103 or any other type of fastening method. In exemplary embodiments, the plate 74 is located between the support member 50 and the mass 38, and the mass 38 is located between the support member 50 and a cover 102 of the tilt indicator 14.

In order for the mass 38 to increase capacitance between the plates 72 and 74, the mass 38 must be very close to the plates 72 and 74. As depicted in FIG. 4, the mass 38 is positioned vertically in the tilt indicator 14 (i.e., in a plane substantially parallel to the cover 102 or the support member 50). As described above, there must be sufficient space between support member 50 and the cover 102 to enable the mass 38 to move freely when tilted and leave receptacle 36. However, too much space or distance between the support member 50 and the cover 102 may result in the mass 38 leaning away from the plates 72 and 74 and toward the cover 102. When the mass 38 leans away from the plates 72 and 74, the mass 38 may be too far away from the plates 72 and 74 to have a sufficient impact on capacitance between the plates 72 and 74 that can be read by the wireless communication module 83 via the capacitance sensor circuit 70.

Thus, in exemplary embodiments of the present disclosure, at least a portion 104 of the plate 74 is biased toward the mass 38 (and towards the cover 102 or away from the support member 50). In other words, the plate 74 is biased towards the mass 38 when the mass 38 is in the unactuated position 39 (i.e., when the mass 38 is in the receptacle region 37). In the illustrated embodiment, the portion 104 of the plate 74 is disposed at an angle relative to the portion 101 toward the mass 38 such that the portion 104 is mechanically biased toward the mass 38 (e.g., similar to a spring clip). However, it should also be understood that the portion 104 may be biased toward the mass 38 using other types of springs or mechanical methods. In exemplary embodiments, since the plate 74 is biased toward the mass 38, the plate 74 has a non-conductive layer 110 disposed over at least a portion of the portion 104 such that the non-conductive layer 110 is disposed between the portion 104 and the mass 38. In other words, the non-conductive layer 110 is disposed on at least a portion of a surface 112 of the plate 74 that faces the mass 38. The non-conductive layer 110 prevents direct contact of the conductive portion of the plate 74 with the conductive mass 38. In exemplary embodiments, the non-conductive layer 110 comprises a thin film so that the mass 38 does not close the electrical gap between the plates 72 and 74. In exemplary embodiments, the non-conductive layer 110 may comprise a layer of polyethylene terephthalate (PET) or polyester film with a thickness of about 0.1 mm. In exemplary embodiments, the elasticity of the non-conductive layer 110 may provide the biasing effect or force to bias the portion 104 toward the mass 38. Thus, in operation, the bias of the plate 74 toward the mass 38 is configured to be sufficient to keep the non-conductive layer 110 near the mass 38 but not so strongly biased that the mass 38 cannot move out of the receptacle 36 when the tilt indicator 14 is tilted.

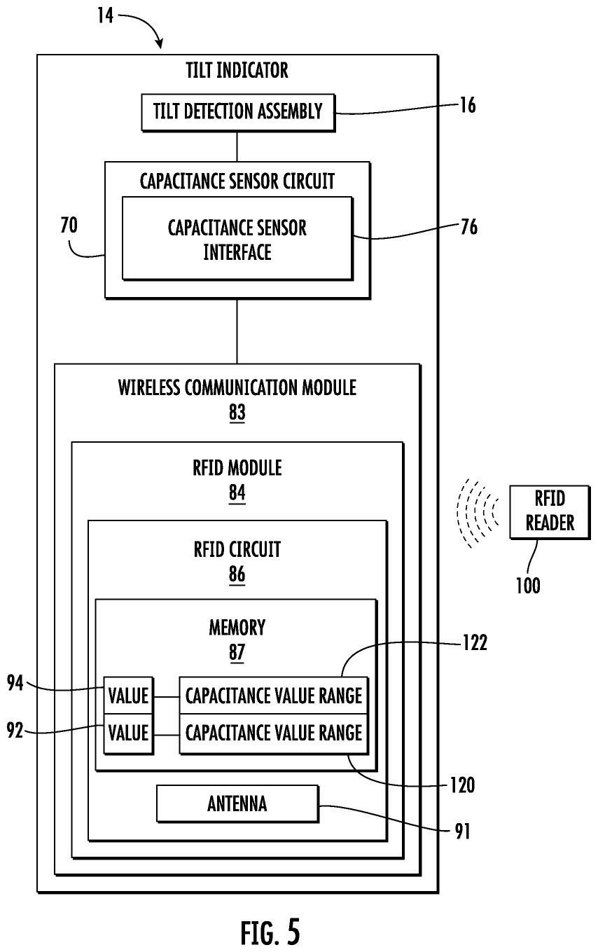

FIG. 5 is a block diagram illustrating an embodiment of the tilt indicator 14 of FIGS. 1-4 according to the present disclosure. In FIG. 5, and as described above, the tilt indicator 14 includes the tilt detection assembly 16, and the capacitance sensor circuit 70 with the capacitance sensor interface 76 coupled to the wireless communication module 83. As described above, the wireless communication module 83 may be a RFID module 84 with an RFID integrated circuit or circuitry 86 (e.g., disposed on or as part of a printed circuit board) and a memory 87, along with the antenna 91. As a passive RFID module 84, the tile indicator 14 does not contain a battery (e.g., power is supplied by a remote RFID reader 100). For example, when radio frequency waves from reader 100 are encountered by the RFID module 84, the antenna 91 provides power to the RFID module 84 to energize the circuitry 86 and the capacitance sensor circuit 70. Once energized, a voltage may be applied to the capacitance sensor circuit 70, and the RFID module 84 may read or otherwise detect a capacitance value between the plates 72 and 74 (FIGS. 2-4). The RFID module 84 may output or wirelessly transmit the read or detected capacitance value to the reader 100. However, it should be understood that, in some embodiments, RFID module 84 may comprise an active RFID module 84 including a power source (e.g., a battery) that may be configured to continuously, intermittently, and/or according to programmed or event triggers, broadcast or transmit certain information. It should also be understood that the wireless communication module 83 may be configured for other types of wireless communication types, modes, protocols, and/or formats (e.g., short-message services (SMS), wireless data using General Packet Radio Service (GPRS)/3G/4G or through public internet via Wi-Fi, or locally with other radio-communication protocol standards such as Wi-Fi, Z-Wave, ZigBee, Bluetooth®, Bluetooth® low energy (BLE), LoRA, UWB, NB-IoT, SigFox, Digital Enhanced Cordless Telecommunications (DECT), or other prevalent technologies).

In exemplary embodiments, the RFID module 84 may output or wirelessly transmit information or an indication of the actuation state of the tilt indicator 14 based on the capacitance value read from the capacitance sensor circuit 70. The RFID module 84 may output or wirelessly transmit the actual capacitance value read from the capacitance sensor circuit 70, or the RFID module may output another value or indication of the actuation state of the tilt indicator 14. For example, in some embodiments, the RFID module 84 may output or wirelessly transmit information encoded in memory 87 based on the read or detected capacitance value from the capacitance sensor circuit 70. In the illustrated embodiment, memory 87 includes at least two different stored and/or encoded values 92 and 94. For example, the value 92 may correspond to a detected capacitance value indicating that the mass 38 is within the receptacle 36 (FIGS. 2-4), and the value 94 may correspond to a detected capacitance value indicating that the mass 38 is not within the receptacle 36 (FIGS. 2-4). As an example, the value 94 may represent an RFID tag identification (ID) number when the mass 38 is within the receptacle 36 (FIGS. 2-4), and the RFID tag's ID number may have an additional character (e.g., “0”) placed at the end thereof. Value 92 may represent the RFID ID number when the mass 38 is not within the receptacle 36 (FIGS. 2-4), and the RFID tag's ID number may have an additional character at the end thereof being different from the additional character carried by value 94 (e.g., “1”).

In exemplary embodiments, the memory 87 may also comprise one or more capacitance value ranges 120 and 122. For example, each capacitance value range 120 and 122 may set forth a particular range of capacitance values. Thus, in exemplary embodiments, the capacitance value range 120 may set forth a range of capacitance values indicating that the mass 38 is within the receptacle 36, and the capacitance value range 122 may set forth a range of capacitance values indicating that the mass 38 is not within the receptacle 36. Accordingly, if the detected or read capacitance value from the capacitance sensor circuit 70 falls within the capacitance value range 120, value 94 is output or transmitted. If the detected or read capacitance value from the capacitance sensor circuit 70 falls within the capacitance value range 122, value 92 is output or transmitted.

The present invention may include computer program instructions at any possible technical detail level of integration (e.g., stored in a computer readable storage medium (or media) (e.g., memory 87) for causing a processor to carry out aspects of the present invention. Computer readable program instructions described herein can be downloaded to respective computing/processing devices (e.g., communication module 83 and/or RFID module 84). Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages. In some embodiments, electronic circuitry (e.g., circuitry 86) including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention. Aspects of the present invention are described herein with reference to illustrations and/or block diagrams of methods and/or apparatus according to embodiments of the invention. It will be understood that each block of the illustrations and/or block diagrams, and combinations of blocks in the illustrations and/or block diagrams, may represent a module, segment, or portion of code, can be implemented by computer readable program instructions. These computer readable program instructions may be provided to a processor or other programmable data processing apparatus to produce a machine, such that the instructions, which execute via the processor, create means for implementing the functions/acts specified in the illustrations and/or block diagram block or blocks. These computer readable program instructions may also be stored in a computer readable storage medium that can direct a computing device, a programmable data processing apparatus, and/or other devices to function in a particular manner, such that the computer readable storage medium having instructions stored therein comprises an article of manufacture including instructions which implement aspects of the function/act specified in the illustrations and/or block diagram block or blocks. The capacitance sensor circuit 70, wireless communication module 83, and/or RFID module 84 may be implemented in any suitable manner using known techniques that may be hardware-based, software-based, or some combination of both. For example, capacitance sensor circuit 70, wireless communication module 83, and/or RFID module 84 may comprise software, logic and/or executable code for performing various functions as described herein (e.g., residing as software and/or an algorithm running on a processor unit, hardware logic residing in a processor or other type of logic chip, centralized in a single integrated circuit or distributed among different chips in a data processing system). Thus, the wireless communication module 83 or the RFID module 84 may comprise logic integrated with and/or executable by the module 83 or 84. As will be appreciated by one skilled in the art, aspects of the present disclosure may be embodied as a system, method or computer program product. Accordingly, aspects of the present disclosure may take the form of a hardware embodiment, a software embodiment (including firmware, resident software, micro-code, etc.) or an embodiment combining software and hardware aspects that may all generally be referred to herein as a “circuit,” “module” or “system.”

Using this system and method described herein, it is possible to very simply and clearly determine whether the tilt indicator 14 has been actuated (i.e. the shipment or product has been subject to tilt) because the number being returned by the RFID tag when it is interrogated is different depending upon the status of tilt indicator 14.

Thus, embodiments of the present disclosure enable tilt event detection using a tilt indicator having a small footprint using a tilt-sensitive assembly with a passive RFID tag that gives a different reading depending upon the status of the capacitance sensor circuit 70. Because the RFID tag is passive, the tilt indicator does not need a battery or other external power source. Further, the configuration of the tilt indictor enables the tilt indicator to be irreversible once activated. Additionally, the tilt indicator of the present disclosure may be configured to be coupled with or in addition to a visual indicator to provide a redundant or additional visual indication of activation.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A tilt indicator, comprising:
a tilt detection assembly including a mass movable from a first position to a second position in response to a tilt event;
a capacitance sensor circuit disposed proximate the first position, the capacitance sensor circuit configured to output a capacitance value based on the mass being in the first position; and
a module and logic integrated with and/or executable by the module, the module coupled to the capacitance sensor circuit, the module configured to output, when energized, an indication of an actuation state of the tilt indicator based on the capacitance value.

2. The tilt indicator of claim 1, wherein the module is configured to wirelessly output the indication when energized.

3. The tilt indicator of claim 1, wherein the capacitance sensor circuit comprises a first conductive plate and a second conductive plate positioned proximate the first position.

4. The tilt indicator of claim 3, wherein the mass comprises a conductive mass.

5. The tilt indicator of claim 1, wherein the module comprises a passive RFID module.

6. The tilt indicator of claim 1, wherein the capacitance value comprises a first capacitance value when the mass is in the first position, and wherein the capacitance sensor circuit is configured to output a second capacitance value when the mass is in the second position.

7. The tilt indicator of claim 1, wherein the capacitance sensor circuit comprises at least one conductive plate positioned proximate the first position and biased towards the mass when the mass is in the first position.

8. A tilt indicator, comprising:
a tilt detection assembly including a mass movable from a first position in response to a tilt event;
a capacitance sensor circuit disposed proximate the first position, the capacitance sensor circuit configured to output a first capacitance value based on the mass being in the first position and a second capacitance value based on the mass being absent from the first position; and
a module and logic integrated with and/or executable by the module, the module coupled to the capacitance sensor circuit, the module configured to output, when energized, an indication of an actuation state of the tilt indicator based on the first capacitance value or the second capacitance value output by the capacitance sensor circuit.

9. The tilt indicator of claim 8, wherein the module includes a passive radio-frequency identification (RFID) module.

10. The tilt indicator of claim 8, wherein the capacitance sensor circuit comprises a first conductive plate and a second conductive plate positioned proximate the first position.

11. The tilt indicator of claim 10, wherein the mass comprises a conductive mass.

12. The tilt indicator of claim 8, wherein the capacitance sensor circuit comprises at least one conductive plate biased toward the mass when the mass is in the first position.

13. A tilt indicator, comprising:
a tilt detection assembly including a mass movable from a first position in response to a tilt event;
a capacitance sensor circuit comprising a first conductive plate and a second conductive plate, the first and second conductive plates disposed proximate the first position; and
a module and logic integrated with and/or executable by the module, the module coupled to the capacitance sensor circuit, the module configured to, when energized:
power the capacitance sensor circuit;
determine a capacitance value from the capacitance sensor circuit; and
output an indication of an actuation state of the tilt indicator based on the capacitance value.

14. The tilt indicator of claim 13, wherein at least one conductive plate of the first and second conductive plates is biased toward the mass when the mass is in the first position.

15. The tilt indicator of claim 13, wherein the capacitance value comprises a first capacitance value when the mass is in the first position, and wherein the capacitance sensor circuit is configured to output a second capacitance value when the mass is absent from the first position.

16. The tilt indicator of claim 13, wherein the module includes a passive radio-frequency identification (RFID) module, and further comprising an arming mechanism, wherein removal or displacement of the arming mechanism places the tilt indicator in an activated state.

17. The tilt indicator of claim 13, wherein at least one conductive plate of the first and second conductive plates comprises a non-conductive layer.

18. The tilt indicator of claim 17, wherein the non-conductive layer is disposed on a surface of the at least one conductive plate facing the mass.

19. The tilt indicator of claim 17, wherein the non-conductive layer comprises a non-conductive film applied to at least a portion of a surface of the at least one conductive plate.

20. The tilt indicator of claim 13, wherein the module is configured to power the capacitance sensor circuit when energized by a remote wireless reader device.
